(19) United States
(12) Patent Application Publication
(10) Pub. No.: US 2017/0061498 A1
(43) Pub. Date: Mar. 2, 2017

(54) PERFORMANCE OF AD CAMPAIGNS TARGETING DEMOGRAPHIC AUDIENCES USING THIRD PARTY DATA

(71) Applicant: Yahoo! Inc, Sunnyvale, CA (US)

(72) Inventors: Mohammad Soltani, Orinda, CA (US); Michael David Snyder, San Francisco, CA (US)

(21) Appl. No.: 14/841,207

(22) Filed: Aug. 31, 2015

(51) Int. Cl. G06Q 30/02

(52) U.S. Cl. CPC G06Q 30/0269

(57) ABSTRACT

The present disclosure describes improving target segments data provided by data management platforms and generating a new target segment that is not available from data management platforms. An advertisement platform compares multiple target segments received from data management platforms. Each of the multiple target segments includes a plurality of items and target group metadata. Then, the advertisement platform retrieves memberships related to the same user or device from the multiple target segments, and determines whether the memberships are logically inconsistent by applying predetermined logical consistency rules. If the memberships are logically inconsistent, the advertisement platform modifies the multiple target segments by eliminating the inconsistent items.

### BACKGROUND

This application relates to a method for improving performance of ad campaigns targeting demographic audiences, more particularly, modifying target segments data provided by data management platforms to improve targeting performance.

In online advertising systems, advertisers often run their advertisements as “advertisement campaigns” in which certain products or services are advertised over a duration (e.g., a week or a month or until a certain time) and targeted towards certain viewers. A large percentage of advertisement campaigns target specific demographic audiences. For example, consumer packaged goods (CPG) campaigns usually target Females who are aged 25-54. Any impression not delivered to the target audience of an advertising campaign is considered a waste of its budget because that specific viewer is unlikely to convert and purchase product or service.

Advertisement platforms usually use user cookie or device identification collections, so called “segments” provided by data management platforms (DMPs) such as BlueKai or eXalate in order to target a specific audience. After advertisement platforms serve advertisements to target groups based on segments, the percentage of a specific campaign impressions served to the intended audience is measured by information and measurement companies such as Nielsen and comScore.

According to the information and measurement companies, campaigns that target both a specific gender and age range based on segments provided by data management platforms on average have less than 50% in-target delivery performance. That is, more than 50% of the targeted advertisements are delivered to an unintended group.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with content server;

FIG. 2 illustrates a block diagram of an example advertising system that includes a target segments modification circuitry;

FIG. 3 is an example flow diagram illustrating embodiments of the disclosure;

FIG. 4 illustrates a block diagram of an example of modifying target segments;

FIG. 5 illustrates a block diagram of other example of modifying target segments;

FIG. 6 illustrates a block diagram of another example of modifying target segments;

FIG. 7 is an example flow diagram illustrating embodiments of the disclosure;

FIG. 8 illustrates a block diagram of an example of providing a new target segment.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### OVERVIEW

One of the technical problems solved by the disclosure is to improve the performance of the audience campaign target segments by running data hygiene techniques on the segment cookies and device identifications. As opposed to original target segments, target segments modified by the data hygiene techniques show improvements on targeting up to 150%.

The present disclosure describes improving target segments data provided by data management platforms and generating a new target segment that is not currently available from data management platforms. Target segments can be improved by data hygiene techniques such as eliminating logically inconsistent items in the target segments. An item is a user cookie for a particular user or a device identification for a particular device and each item may be a member to multiple target segments. In other words, each item may have membership to those target segments. Likewise, target segments may have a membership that includes a plurality of items. Logical characteristics of segments can be stored as segments metadata. This metadata is used as a reference in determining whether any two items are logically inconsistent.

In a first aspect, an advertisement platform compares multiple target segments received from data management platforms. Each of the multiple target segments includes a plurality of items and its metadata. Then, the advertisement platform retrieves all memberships related to the same user or device from the multiple target segments, and determines whether these memberships are logically inconsistent based on the each of the multiple target segments metadata. If user memberships are found to be logically inconsistent, the advertisement platform eliminates the corresponding user from all inconsistent target segments.

In a second aspect, an advertisement platform integrates multiple target segments. Each of the multiple target segments includes a plurality of items and its metadata. The advertisement platform receives desired targeting criteria for which it does not have high-quality or representative target segments. The advertisement platform retrieves all target segments related to the targeting criteria. The advertisement platform combines all users from the retrieved segments into a combined table of users or devices. For each user or device in the combined table, the advertisement platform retrieves all segment memberships related to the same user or device. Then, the advertisement platform determines whether these memberships are logically inconsistent based on the retrieved segment metadata. If memberships are found to be logically inconsistent, the advertisement platform eliminates the user or device from the combined table. The advertisement platform, then, selects all users in the combined table that fall within the desired targeting criteria. The advertisement platform generates a new target segment which includes all selected users or devices.

The present disclosure improves the percentage of in-target delivery performance by eliminating noise data from segments provided by a third party. In addition, the present disclosure enables an advertisement platform to generate a customized target segment by integrating multiple target segments, eliminating noise data, and extracting relevant items from the integrated multiple target segments.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

While the publisher and social networks collect more and more user data through different types of e-commerce applications, news applications, games, social networks applications, and other mobile applications on different mobile devices, a user may be tagged with different features accordingly. Using these different tagged features, online advertising providers may create more and more audience segments to meet the different targeting goals of different advertisers. Thus, it is desirable for advertisers to directly select the audience segments with the best performances using keywords. Further, it would be desirable to the online advertising providers to provide more efficient services to the advertisers so that the advertisers can select the audience segments without reading through the different features or descriptions of the audience segments.

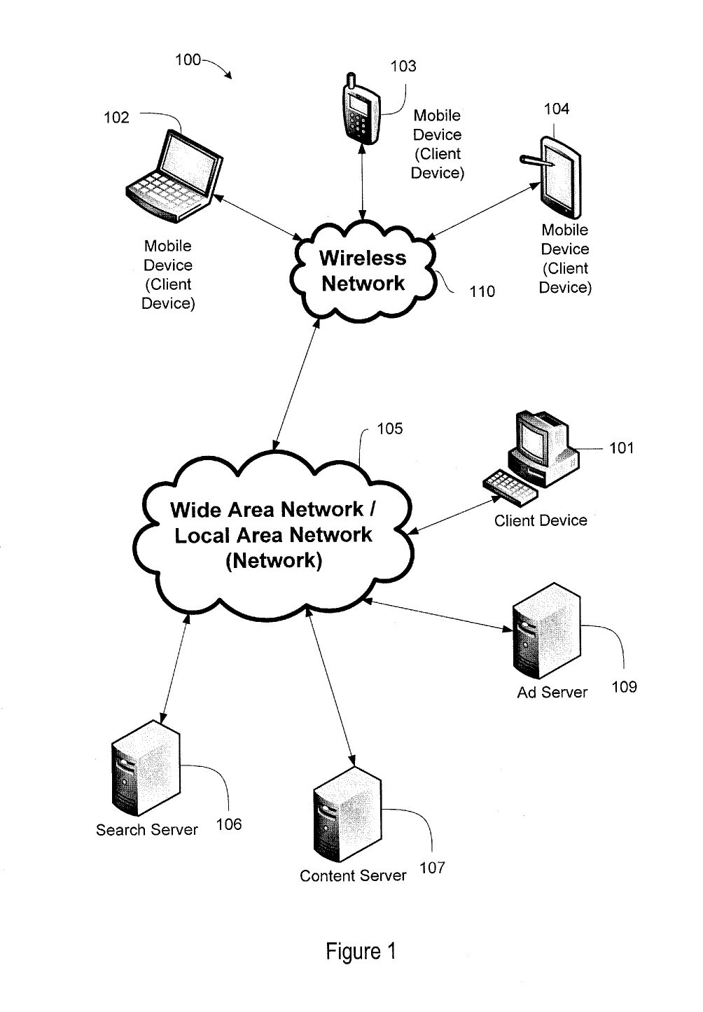

FIG. 1 is a schematic diagram illustrating an example embodiment of a network. Other embodiments that may vary, for example, in terms of arrangement or in terms of type of components, are also intended to be included within claimed subject matter. As shown, FIG. 1, for example, includes a variety of networks, such as local area network (LAN)/wide area network (WAN) 105 and wireless network 110, a variety of devices, such as client device 101 and mobile devices 102, 103, 104, and a variety of servers, such as search server 106, content server 107, and ad server 109.

The client device 101 may include a computing device capable of sending or receiving signals, such as via a wired or a wireless network. The client 101 device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

The client device 101 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The client device 101 may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interlaces, or one or more operating systems, such as Windows Server, Mac OS X, Unix, Linux, FreeBSD, or the like.

The content server 107 may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

The content server 107 may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

A network such as the LAN/WAN 105 and the wireless network 110 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The ad server 109 includes a server that stores online advertisements for presentation to users. “Ad serving” refers to methods used to place online advertisements on websites, in applications, or other places where users are more likely to see them, such as during an online session or during computing platform use, for example.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

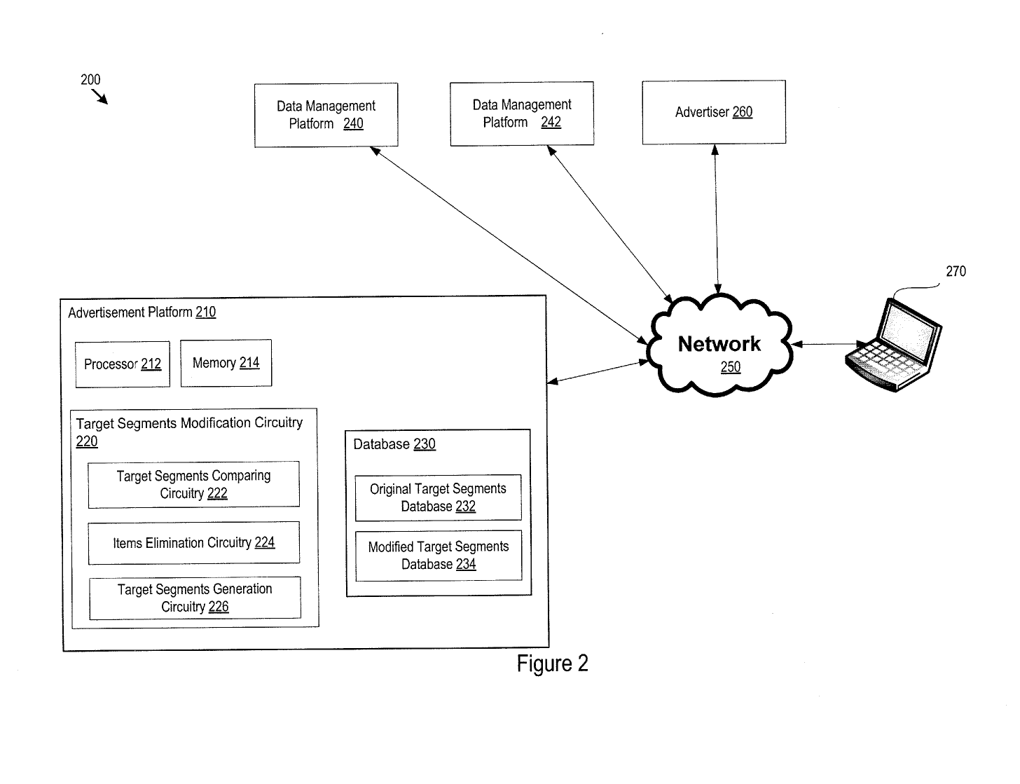

FIG. 2 illustrates a block diagram of an example advertising system that includes a target segments modification circuitry. The advertising system 200 includes an advertisement platform 210, data management platforms 240, 242, advertiser 260, network 250, and a client device 270. The advertisement platform 210 may include a content server such as the content server 107 and an ad server such as the ad server 109 as shown in FIG. 1. The advertiser 260 may include an ad server such as the ad server 109 in FIG. 1. The advertisement platform 210, the data management platforms 240, 242, the advertiser 260 and the client device 270 may communicate with each other through the network 270. The network 270 may be any network described with reference to FIG. 1.

The advertisement platform 210 includes a processor 212, memory 214, target segments modification circuitry 220, and database 230. The target segments modification circuitry 220 may include target segments comparing circuitry 222, items elimination circuitry 224, and target segments generation circuitry 226. The database 230 may include original target segments database 232 and modified target segments database 234.

The target segments comparing circuitry 222 operates to compare target segments received from the data management platforms 240, 242. The target segments comparing circuitry 222 may receive target segments from the data management platforms periodically, for example, every day or once in a week. Each of the target segments includes target metadata, for example, (Male, Age 25-44), (Female, Age 25-44), or (Democratic). Each of the target segments includes a plurality of items each of which includes a user cookie or a device identification. A user cookie is a small piece of data sent from a website and stored in a user's web browser while the user is browsing the web browser. A device identification is a distinctive number associated with an electronic device such a smartphone or similar handheld device. Device identifications are separate from hardware serial numbers.

The target segments comparing circuitry 222 compares two target segments and determines whether the same user cookie or device identification exists in both target segments. For example, the target segments comparing circuitry 222 compares target segment A (Age 25-44) and target segment B (Age 18-24) and finds that a user cookie “67asdf89” is present both in the target segment A and the target segment B. Then, the target segments comparing circuitry 222 determines whether the two target group metadata related to the same user cookie or device identification are logically inconsistent. In the above example, the user cookie “67asdf89” belongs to the target segment A and the target segment B, and the target group age bracket of the target segments A and B are logically inconsistent or exclusive to each other. That is, a single user cannot be both age 25-44 and age 18-24. Logical inconsistencies may be referred to as being mutually exclusive. Any mutually exclusive overlaps within a segment may be ignored as described herein.

The items elimination circuitry 224 operates to eliminate items that are belong to two inconsistent or exclusive target segments. In the above example, the items elimination circuitry 224 eliminates the user cookie “67asdf89” from both the target segment A and the target segment B. The modified target segments may be stored in the modified target segments database 234. In this regard, the advertisement platform 210 may reduce the size of target segments data.

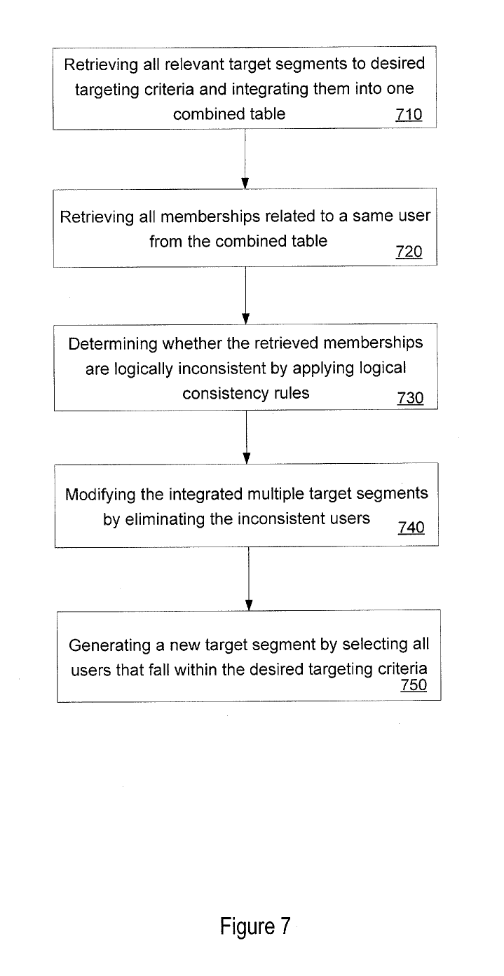

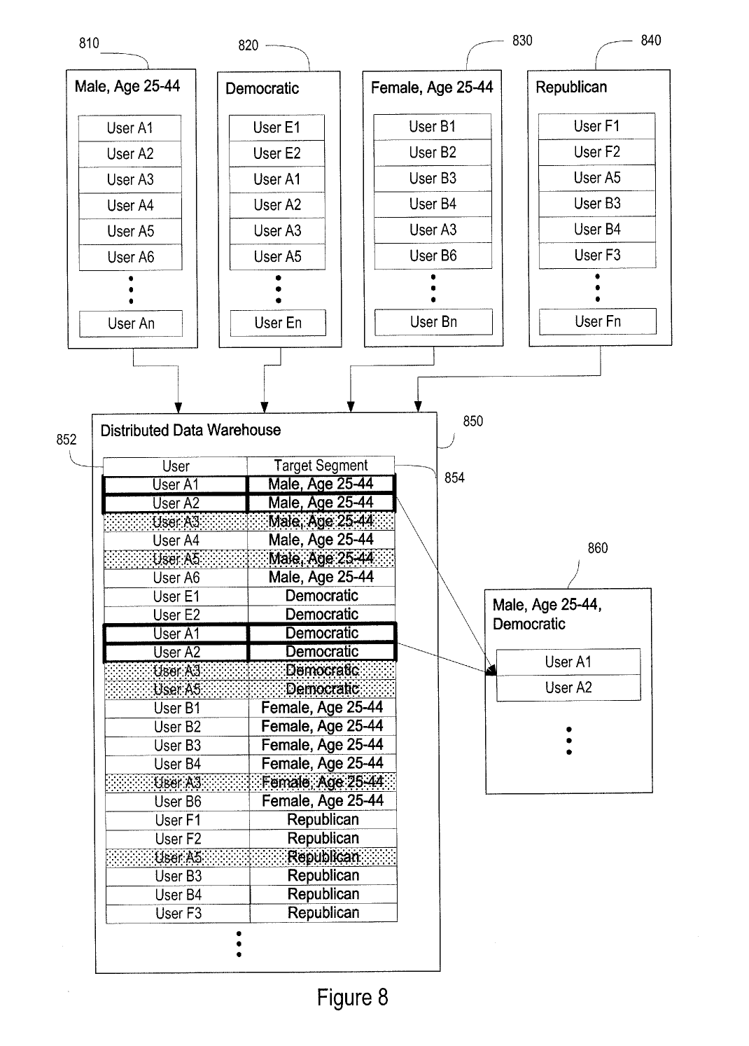

The target segments generation circuitry 226 operates to generate a new target segment based on multiple target segments received from the data management platforms 240, 242. The target segments generation circuitry 226 may generate new target group metadata based on the combination of target group metadata of multiple target segments. For example, if multiple target segments include target group metadata of (Male, Age 25-44), (California) or (Female, Age 25-44), (Democratic), respectively, the target segments generation circuitry 226 may generate a new target group metadata of (Male, Age 25-44, California) or (Female, Age 25-44, Democratic). Then, the target segments generation circuitry 226 may extract a set of items that are associated with the new target group metadata from the multiple target segments. The detailed description of generating a new target segments will be discussed below with reference to FIGS. 7 and 8.

The database 230 may include original target segments database 232 and modified target segments database 234. Although FIG. 2 illustrates the database 230 is included in the advertisement platform 210, the database may be present external to the advertisement platform 210 as a distributed data warehouse such as a cloud data warehouse. A distributed data warehouse is a database in which portions the database are stored on multiple computers within a network.

Original target segments database 232 stores original target segments that are received from the data management platform 240 and 242. The original target segments database stores each item of the target segments in association with target group metadata. For example, each row of the database includes an item such as a user cookie or a device identification, and specific target group metadata such as “Male.”

The modified target segments database 234 stores target segments modified by the items elimination circuitry 224. The modified target segments 234 may similarly store each item of the modified target segments in association with target group metadata.

The advertisement platform 210 may utilize the modified target segments when serving advertisements to a certain target group requested by the advertiser 260. Because unreliable data such as logically inconsistent or mutually exclusive items have been already eliminated from the original target segments, in-target delivery performance of the modified target segments is significantly improved up to 150%. Advertisers would be more willing to purchase from the advertisement platform that provide modified target segments because of high in-target delivery performance.

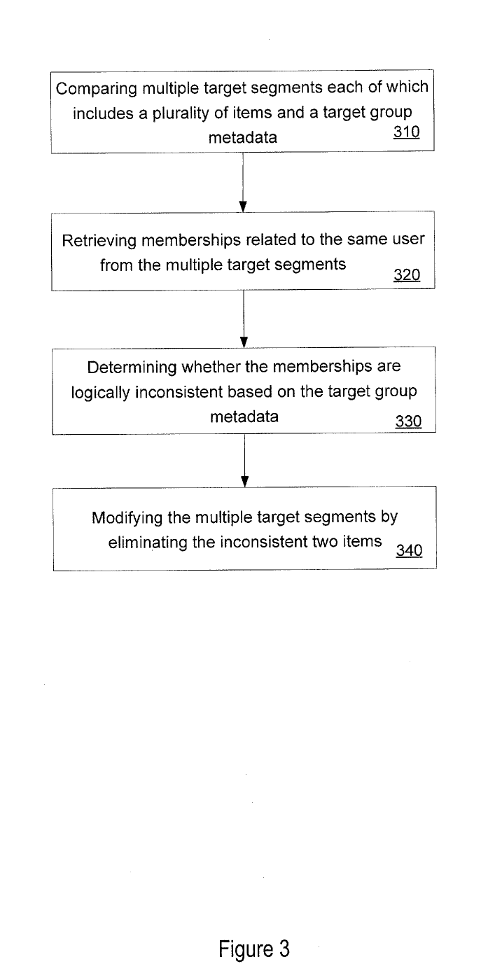

FIG. 3 is an example flow diagram illustrating embodiments of the disclosure. The target segments comparing circuitry 222 compares multiple target segments each of which includes a plurality of items and target group metadata (310). The items may include user cookies and/or device identifications. The target group metadata may include demographic information such as age, gender, education, marital status, and income level. The multiple target segments may be received from the data management platforms 240, 242 and stored in the original target segments database 232. The target segments comparing circuitry 222 may compare items of the multiple target segments.

Then, the target segments comparing circuitry 222 retrieves memberships related to the same user from the multiple target segments (320). For example, the target segments comparing circuitry 222 may find a user cookie “1234asdf” in a target segment A and find the same user cookie “1234asdf” in a target segment B.

With respect to the retrieved memberships, the items elimination circuitry 230 determines whether these memberships are logically inconsistent based on the target group metadata (330). For example, if the user cookie “1234asdf” appears in a target segment with a target group metadata of “Age 25-44” and the same user cookie “1234asdf” appears in a target segment with a target group metadata of “Age 18-24,” then the items elimination circuitry 230 finds the user cookies “1234asdf” in both target segments are logically inconsistent or mutually exclusive because a user cannot be both age 25-44 and age 18-24. In contrast, if the user cookie “1234asdf” appears in a target segment with a target group metadata of “Age 25-44” and the same user cookie “1234asdf” appears in a target segment with a target group metadata of “democratic,” the items elimination circuitry 230 would not find logical inconsistency because a user can be both age 25-44 and democratic. The logical inconsistency may be determined by applying logical consistency rules that are stored in a table on the advertisement platform 210. The logical consistency rules may be constructed on a plurality of metadata entries, each of which includes an example logical inconsistency. For example, a metadata entry may include (Male) and (Female) as a logical inconsistency example. In other example, a metadata entry may include (Age 25-44) and (Age 18-24) as a logical inconsistency example. In another example, a metadata entry may include (Married couple) and (Single) as a logical inconsistency example. The logical inconsistency rules may be updated in real time by the administrator of the advertisement platform 210.

The logical inconsistency rules may include numbers representing target groups that are logically inconsistent. For example, if a number representing a target group of (Age 25-44) is 71235 and a number representing a target group of (Age 18-24) is 71234, then the logical inconsistency rules may include numbers 71234 and 71235 as a metadata entry.

The items elimination circuitry 230 then modifies the multiple target segments by eliminating the inconsistent items from the multiple target segments (340). The modified multiple target segments may be stored in the modified target segments database 234.

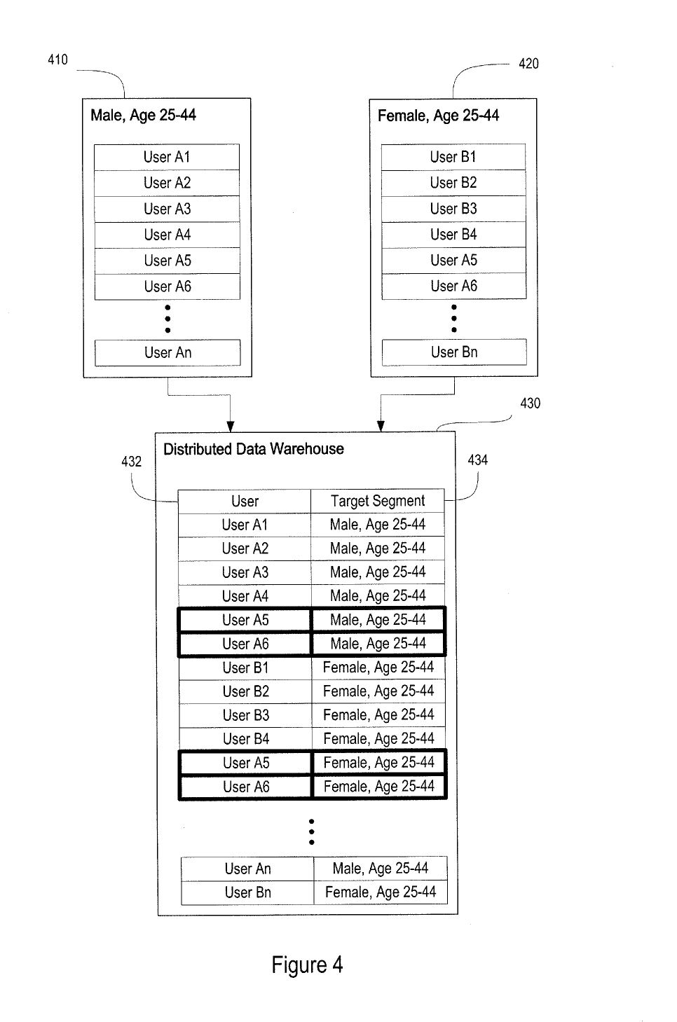

FIG. 4 illustrates a block diagram of an example of modifying target segments. The target segments 410 and 420 are received from one data management platform such as the data management platform 240. Alternatively, the each of target segments 410 and 420 may be received from different data management platforms, for example, the data management platform 240 and the data management platform 242, respectively.

The target segment 410 includes target group metadata of “Male, Age 25-44” and the target segment 420 includes target group metadata of “Female, Age 25-44.” The target group metadata may be a collection of random numbers that represent the target group, for example, 53216 for “Male”, 65828 for “Age 25-44” and 53116 for “Female.” The target segment 410 includes a plurality of items, for example, User A1 through An. The items may be user cookies and/or device identification. Similarly, the target segment 420 includes a plurality of items, for example, B1 through B4, A5, A6, . . . , Bn.

The target segments 410 and 420 are stored in a distributed data warehouse 430. As illustrated in FIG. 4, the target segments 410 and 420 may be stored in a plurality of rows that include a user column 432 and a target segment membership column 434. In other embodiments, the target segments 410 and 420 may be stored in the distributed data warehouse 430 in original forms.

As indicated in bold lines, User A5 and User A6 are present both in the target segment 410 with the target group metadata of “Male, Age 25-44” and the target segment 420 with the target group metadata of “Female, Age 25-44.” Because a user cannot be both a “male, age 25-44” and a “female, age 25-44,” the items User A5 and User A6 have logical inconsistency. In this regard, the items elimination circuitry 224 eliminates User A5 and User A6 from both the target segment 410 and the target segment 420.

Although FIG. 4 illustrates two target segments, more than two target segments may be compared with each other, and inconsistent items can be eliminated. For example, in addition to the target segments 410 and 420, a target segment with a description of “Female, Age 18-24” also can be compared.

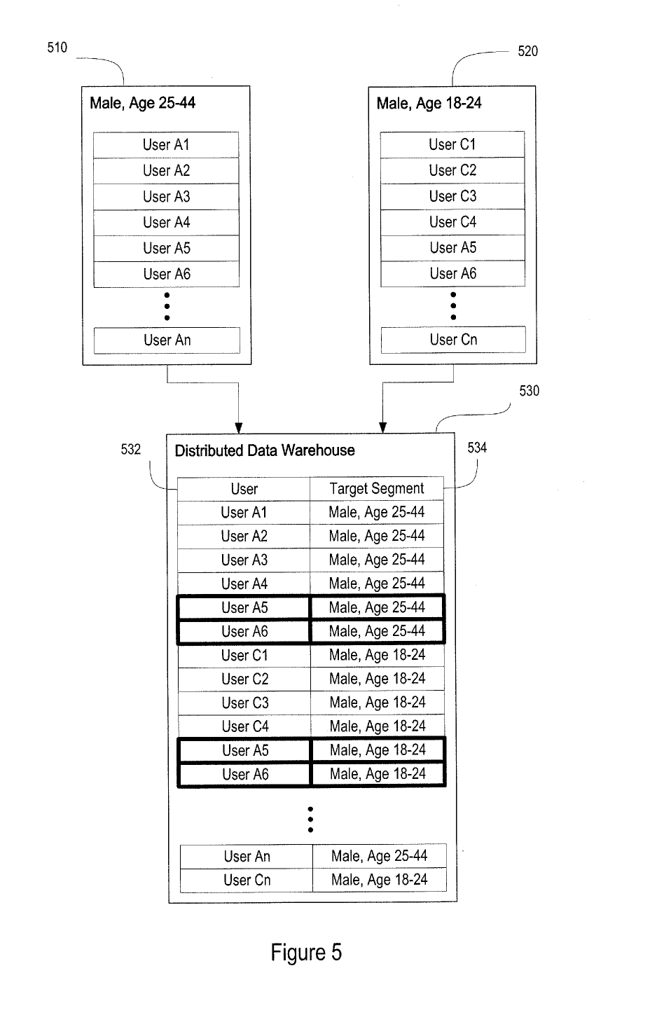

FIG. 5 illustrates a block diagram of other example of modifying target segments. The target segments 510 and 520 are received from one data management platform such as the data management platform 240. Alternatively, the each of target segments 510 and 520 may be received from different data management platforms, for example, the data management platform 240 and the data management platform 242, respectively.

The target segment 510 includes target group metadata of “Male, Age 25-44” and the target segment 520 includes target group metadata of “Male, Age 18-24.” The target segment 510 includes a plurality of items, for example, User A1 through An. The items may be user cookies and/or device identification. Similarly, the target segment 520 includes a plurality of items, for example, C1 through C4, A5, A6, . . . , Cn.

The target segments 510 and 520 are stored in a distributed data warehouse 530. As illustrated in FIG. 5, the target segments 510 and 520 may be stored in a plurality of rows that include a user column 532 and a target segment membership column 534. In other embodiments, the target segments 510 and 520 may be stored in the distributed data warehouse 530 in original forms.

As illustrated in bold lines, User A5 and User A6 are present both in the target segment 510 with the target group metadata of “Male, Age 25-44” and the target segment 520 with the target group metadata of “Male, Age 18-24.” Because a user cannot be both a “Male, age 25-44” and a “Male, age 18-24,” the items User A5 and User A6 have logical inconsistency. In this regard, the items elimination circuitry 224 eliminates User A5 and User A6 from both the target segment 510 and the target segment 520.

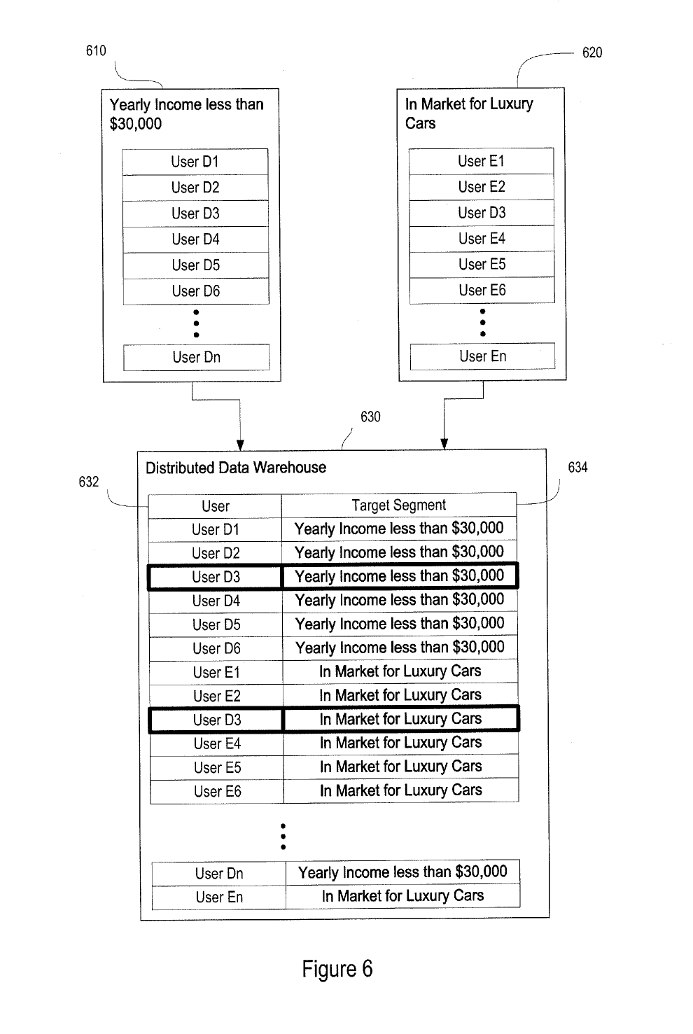

FIG. 6 illustrates a block diagram of another example of modifying target segments. The target segments 610 and 620 are received from one data management platform such as the data management platform 240. Alternatively, the each of target segments 610 and 620 may be received from different data management platforms, for example, the data management platform 240 and the data management platform 242, respectively.

The target segment 610 includes a target group metadata of “Yearly Income less than $30,000” and the target segment 620 includes target group metadata of “In Market for Luxury Cars.” The target segment 610 includes a plurality of items, for example, User D1 through Dn. The items may be user cookies and/or device identification. Similarly, the target segment 620 includes a plurality of items, for example, E1, E2, D3, E4 through En.

The target segments 610 and 620 are stored in a distributed data warehouse 630. As illustrated in FIG. 6, the target segments 610 and 620 may be stored in a plurality of rows that include a user column 632 and a target segment membership column 634. In other embodiments, the target segments 610 and 620 may be stored in the distributed data warehouse 630 in original forms.

As illustrated in bold lines, User D3 is present both in the target segment 610 with the target group metadata of “Yearly Income less than $30,000” and the target segment 620 with the target group description of “In Market for Luxury Cars.” Because it is very unlikely that a user belongs to a group of “Yearly Income less than $30,000” and “In Market for Luxury Cars,” the item User D3 may be determined to have logical inconsistency. In this regard, the items elimination circuitry 224 eliminates User D3 from both the target segment 610 and the target segment 620.

Logical consistency rules may be predetermined and stored in memory of the advertisement platform 210, for example in memory 214. For example, logical inconsistency may include examples of age inconsistency, gender inconsistency, and user preference inconsistency. The items elimination circuitry 224 may determine whether two items belonging to different target groups have logical inconsistency by simply referring to the logical inconsistency rules stored in the memory 214. For example, a target segment of “college students” and a target segment of “retirees” may be predetermined to be logically inconsistent and this information may be stored in the memory 214. When a single user cookie belongs to both a target segment of “college students” and a target segment of “retirees,” the items elimination circuitry 224 finds logical inconsistency by referring the predetermined rule and eliminates the user cookie from both target segments.

FIG. 7 is an example flow diagram illustrating embodiments of the disclosure. The target segments modification circuitry 220 receives desired targeting criteria for which it has not integrated a high-quality or representative target segment. The target segment modification circuitry 220 retrieves all relevant target segments to the desired targeting criteria by executing a search on the metadata of integrated target segments and integrates the relevant target segments into one combined table (710). The integrated target segments consist of multiple target segments. Each of the multiple target segments includes a plurality of items and its metadata. The multiple target segments may be received from the data management platforms 240, 242 and stored in the original target segments database 232. The combined table may include a column of items such as user cookies or device identifications, and a column of the target segment membership.

Then, for each user in the combined table, the target segments comparing circuitry 222 retrieves all memberships related to a same user (720). For example, the target segments comparing circuitry 222 may find a unique device identification “qwer6789” in a target segment A and find the same unique device identification “qwer6789” in a target segment B.

With respect to the retrieved memberships, the items elimination circuitry 230 determines whether these memberships are logically inconsistent by applying logical consistency rules that are stored in a table on the advertisement platform 210 (730). For example, if the unique device identification “qwer6789” appears in a target segment with target group description of “California” and the same unique device identification “qwer6789” appears in a target segment with target group description of “Illinois,” then the items elimination circuitry 230 finds the unique device identification “qwer6789” in both target segments are logically inconsistent because it is unlikely that a user is a resident of both California and Illinois.

In contrast, if the unique device identification “qwer6789” appears in a target segment with target group description of “California” and the same unique device identification “qwer6789” appears in a target segment with target group description of “San Francisco,” the items elimination circuitry 230 would not find logical inconsistency because a user can be both in California and in San Francisco.

The items elimination circuitry 230 then modifies the integrated multiple target segments by eliminating the inconsistent users from the combined table (740). The modified combined table may be stored in the modified target segments database 234.

The target segments generation circuitry 226 generates a new target segment by selecting all users that fall within the desired targeting criteria (750). The target segments generation circuitry 226 may generate new target group metadata from the desired targeting criteria.

The above algorithm can be applied over and over again to the same set of cookies and device identifications for the same desired targeting criteria. After a new batch of cookies and device identifications are received from data management platforms into the integrated target segments on the advertisement platform 210, the target segments modification circuitry 220 can update all the relevant target segments in the combined table and re-run logical consistency rules. If desired targeting criteria consist of user characteristics that rarely change over times such as gender, ethnicity, level of education, or political affiliation, the accuracy of a generated target segment usually increases with each repeat resulting in higher quality targeting data that is not available from data management platforms 240 and 242 directly. For example, a new desired targeting criteria may be a combination of (Male) and (Asian). Because gender and race are non-variant characteristics, generating a new target segment using successive runs of the algorithm described above generates a highly accurate segment that can match performance of first party data collected from the user self-declaration. Such a generated segment can be used for targeting by the advertisement platform 210 significantly longer than unmodified targeting segments supplied by data management platforms 240 and 242 since characteristics such as gender and race rarely change.

In contrast, successive runs of the algorithm described above may not increase accuracy of the target segment generated for the desired targeting criteria of (Female) and of (Planning for Wedding), because people who used to be interested in wedding may no longer have interests in wedding related advertisements after getting married.

Similarly, desired targeting criteria may include user characteristics that change expectedly such as age. For example, the advertisement platform 210 may generate a high-quality target segment for the desired targeting criteria of (Male, Age 25-44) in year 2015. The same target segment can be used to target (Male, Age 26-45) in year 2016.

FIG. 8 illustrates a block diagram of an example of providing a target segment for desired targeting criteria for which the advertisement platform 210 has not integrated a high-quality target segment. The target segments 810, 820, 830, and 840 are received from one data management platform such as the data management platform 240. Alternatively, the each of target segments 810, 820, 830, and 840 may be received from different data management platforms.

The target segment 810 includes target group metadata of “Male, Age 25-44,” the target segment 820 includes a target group metadata of “Democratic,” the target segment 830 includes a target group metadata of “Female, Age 25-44”, and the target segment 840 includes a target group metadata of “Republican”. The target segment 810 includes a plurality of items, for example, User A1 through An. The items may be user cookies or device identification. Similarly, the target segment 820 includes a plurality of items, for example, E1, E2, A1, A2, A3, A5, . . . , En, the target segment 830 includes a plurality of items, for example, B1, B2, B3, B4, A3, B6, . . . , Bn, and the target segment 840 includes a plurality of items, for example, F1, F2, A5, B3, B4, F3, . . . , Fn.

The target segments 810, 820, 830, and 840 may be stored in a distributed data warehouse 850. As illustrated in FIG. 8, the target segments 810, 820, 830, and 840 may be integrated into a table including a user column 852 and a target segment membership column 854. In other embodiments, the target segments 810, 820, 830, and 840 may be stored in the distributed data warehouse 430 in original forms.

As illustrated in shaded blocks in FIG. 8, User A3 is present in the target segments of “Male, Age 25-44,” “Democratic,” and “Female, Age 25-44.” Because a user cannot be both a “Male, age 25-44” and a “Female, age 25-44,” the item User A3 has logical inconsistency. Similarly, as illustrated in shaded blocks in FIG. 8, User A5 is present in the target segments of “Male, Age 25-44,” “Democratic,” and “Republican.” Because a user is not likely to be both a “Democratic” and a “Republican,” the item User A5 has logical inconsistency. In this regard, the items elimination circuitry 224 eliminates Users A3 and A5 from the combined table in the distributed data warehouse 850.

A target segment 860 is a new target segment based on the integrated multiple target segments stored in the distributed data warehouse 850. The target segment 860 includes new target group metadata of “Male, Age 25-44, Democratic.”

Once a new target group metadata is generated, a set of items that belong to the new target segment are selected from the combined table. For example, User A1 and User A2 belong to the target segments of “Male, Age 25-44” and “Democratic.” Thus, the items User A1 and User A2 will become the member of the new target segment 860. With new target segments such as the target segment 860, the advertisement platform 210 is able to provide customized target group that is desired by an advertiser.

For example, if an advertiser wants to advertise its product to a target group of (Female, Age 44-55, College Graduated), and data management platforms only provide third-party-provided target segments of (Female, Age 44-55) and (College Graduated) respectively, the advertisement platform may not be able to provide a high-quality target segment that performs well to the advertiser's expectation. By integrating multiple segments and eliminating logically inconsistent items, the advertisement platform is able to provide a more precise target segment that meets the advertiser's goal of marketing.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

What is claimed is:

1. A method for improving audience campaign targeting data, the method comprising:
comparing multiple target segments, each of the multiple target segments including a plurality of items and metadata of the target group;
retrieving memberships related to items representing a same user from the multiple target segments;
determining whether the memberships are logically inconsistent based on target group metadata related to the memberships; and
modifying the multiple target segments by eliminating the items related to the logically inconsistent memberships.

2. The method of claim 1, wherein each of the plurality of items includes a user cookie or a device identification.

3. The method of claim 1, wherein determining whether the memberships are logically inconsistent based on the target group metadata comprises:
applying predetermined logical consistency rules to the memberships related to the items representing the same user in multiple target segments.

4. The method of claim 3, wherein the memberships are logically inconsistent when one of the memberships in one target segment is a mutually exclusive overlapping of other membership of the memberships in other target segments.

5. The method of claim 1, further comprising
storing the multiple target segments in distributed data warehouse.

6. The method of claim 1, wherein the target group metadata includes demographic information or personal preference.

7. The method of claim 1, wherein the eliminating the items related to the logically inconsistent memberships comprises ignoring the items related to the logically inconsistent memberships.

8. The method of claim 7, further comprising:
establishing a profile after ignoring the items related to the logically inconsistent memberships.

9. A method for improving audience campaign targeting data, the method comprising:
integrating multiple target segments, each of the multiple target segments including a plurality of items and metadata of the target group;
retrieving memberships related to items representing a same user from the integrated multiple target segments;
determining whether the memberships are logically inconsistent based on target group metadata related to the memberships;
modifying the integrated multiple target segments by eliminating the items related to logically inconsistent memberships; and
generating a new target segment including a set of items associated with desired targeting criteria, the set of items being selected from the modified integrated multiple target segments.

10. The method of claim 9, wherein the new target segment includes a new target group metadata consisting of user characteristics that rarely changes over time.

11. The method of claim 9, wherein each of the plurality of items includes a user cookie or a device identification.

12. The method of claim 9, wherein determining whether the memberships are logically inconsistent based on the target group metadata:
applying predetermined logical consistency rules to the memberships related to items representing the same user in multiple target segments.

13. The method of claim 9, further comprising
storing the multiple target segments in distributed data warehouse.

14. The method of claim 9, wherein the target group metadata includes demographic information or personal preference.

15. A machine-readable non-transitory storage medium having stored thereon a computer program comprising at least one code section for providing advertisements, the at least one code section being executable by a machine for causing the machine to perform a method comprising:
comparing multiple target segments, each of the multiple target segments including a plurality of items and metadata of the target group;
retrieving memberships related to items representing a same user from the multiple target segments;
determining whether the memberships are logically inconsistent based on the target group metadata related to the memberships; and
modifying the multiple target segments by eliminating the items related to the logically inconsistent memberships.

16. The machine-readable non-transitory storage medium of claim 15, wherein each of the plurality of items includes a user cookie or a device identification.

17. The machine-readable non-transitory storage medium of claim 15, wherein determining whether the memberships are logically inconsistent comprises:
applying predetermined logical consistency rules to the memberships.

18. The machine-readable non-transitory storage medium of claim 15, wherein the target group metadata includes a certain number corresponding to each of the target group metadata.

19. The machine-readable non-transitory storage medium of claim 15, wherein the method further comprising:
storing the multiple target segments in distributed data warehouse.

20. The machine-readable non-transitory storage medium of claim 15, wherein the target group metadata includes a gender and an age range.
